(19) United States
(12) Patent Application Publication
(10) Pub. No.: US 2005/0219464 A1
(43) Pub. Date: Oct. 6, 2005

(54) Semiconductor light-emitting device and video display adopting it

(75) Inventors: Futoshi Yamasaki, Yokohama (JP); Masahiko Yatsu, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/058,860

(22) Filed: Feb. 15, 2005

(30) Foreign Application Priority Data
Mar. 30, 2004 (JP) 2004-099206

(51) Int. Cl. G03B 21/14

(52) U.S. Cl. 353/20

(57) ABSTRACT

An LED technology is adapted to a video display in order to ensure high image quality. A semiconductor light-emitting device having a flip-chip structure is adopted as a light source. Polarized light of white light or of each of red, green, and blue light waves, of which one polarized light component is converted to become consistent with the other component, is radiated from the light source. In the semiconductor light-emitting device, a light transmissive substrate or a quarter-wave phase difference plate that turns the direction of polarization, and a reflective sheet polarizer that reflects one of P-polarized light and S-polarized light and transmits the other polarized light are disposed on the light-emitting side of an LED chip light emitter formed on a reflecting electrode. The direction of polarization of polarized light reflected from the reflective sheet polarizer or reflecting electrode is turned by the substrate or quarter-wave phase difference plate so that it will be aligned with the direction of polarization of the other polarized light. The resultant polarized light is transmitted by the reflective sheet polarizer and then radiated from the semiconductor light-emitting device.

### CROSS-REFERENCES TO RELATED APPLICATIONS

The present application is related to and claims priority from Japanese Patent Application No. 2004-099206, filed Mar. 30, 2004, and is hereby incorporated by reference for all purposes.

### BACKGROUND OF THE INVENTION

The present invention relates to a video display technology for displaying video by irradiating light emitted from a light source to a video display device so as to thus form an optical image.

Arts related to the present invention include those described in, for example, Japanese Unexamined Patent Application Publication No. 2003-329978 and Japanese Unexamined Patent Application Publication No. 2000-221596. Japanese Unexamined Patent Application Publication No. 2003-329978 describes a structure used in a projection type display. The structure employs LEDs that emit red, green, and blue color light waves respectively, and having a phase difference plate, a tapered rod lens array, a rod lens array, and a reflective sheet polarizer arranged outside the LEDs for the purpose of a compact, thin, and lightweight design. Japanese Unexamined Patent Application Publication No. 2000-221596 describes a light source for projection type displays employing LEDs. The light source includes a plurality of LEDs arranged on a plurality of inclined surfaces of a substrate, which reflects light, for the purpose of preventing interference of light waves emitted from adjoining LEDs.

### BRIEF SUMMARY OF THE INVENTION

The present invention can provide a video display technology for producing a thin light beam of parallel rays so as to ensure high image quality for displayed video, and for reducing the number of optical elements to be disposed on an optical path.

According to the present invention, semiconductor light-emitting devices each having a flip-chip structure that a light-emitting diode (LED) chip light emitter are formed on a reflecting electrode. The devices can be used as a light source in a video display. Polarized light of white light, or color components of red, green, and blue light waves, wherein a first polarization is converted to become consistent with a second polarization is radiated from the light source. In the semiconductor light-emitting device, a light transmissive substrate element turns a direction of polarization. A reflective sheet polarizer element reflects one of P-polarized light or S-polarized light and transmits the other polarized light. These elements are disposed on the light-emitting side of the LED chip light emitter. The light transmissive substrate (or quarter-wave phase difference plate) is used to turn the direction of polarization of polarized light, which is reflected from the reflective sheet polarizer or reflecting electrode, so that the direction of polarization will be aligned with the direction of polarization of the other polarized light. The resultant polarized light is transmitted by the reflective sheet polarizer and then radiated.

The present invention provides a light source unit adopting the foregoing semiconductor light-emitting device incorporated in a video display. An optical unit adopting the light source unit is also contemplated by the present invention.

According to the present invention, high image quality video can be produced, and the number of optical elements disposed on an optical path can be reduced.

### BRIEF DESCRIPTION OF THE DRAWINGS

These and other features, objects and advantages of the present invention will become more apparent from the following description when taken in conjunction with the accompanying drawings wherein:

FIG. 1 illustrates the structure of a semiconductor light-emitting device in accordance with the first embodiment of the present invention;

FIG. 2 illustrates the configuration of a video display adopting the semiconductor light-emitting device shown in FIG. 1;

FIG. 3 illustrates the configuration of a video display in accordance with the second embodiment of the present invention;

FIG. 4 illustrates the configuration of a video display in accordance with the third embodiment of the present invention;

FIG. 5 illustrates the configuration of a video display in accordance with the fourth embodiment of the present invention; and

FIG. 6 illustrates the configuration of a semiconductor light-emitting device in accordance with the fifth embodiment of the present invention.

### DETAILED DESCRIPTION OF THE INVENTION

The best mode for implementing the present invention will be described below in conjunction with the drawings.

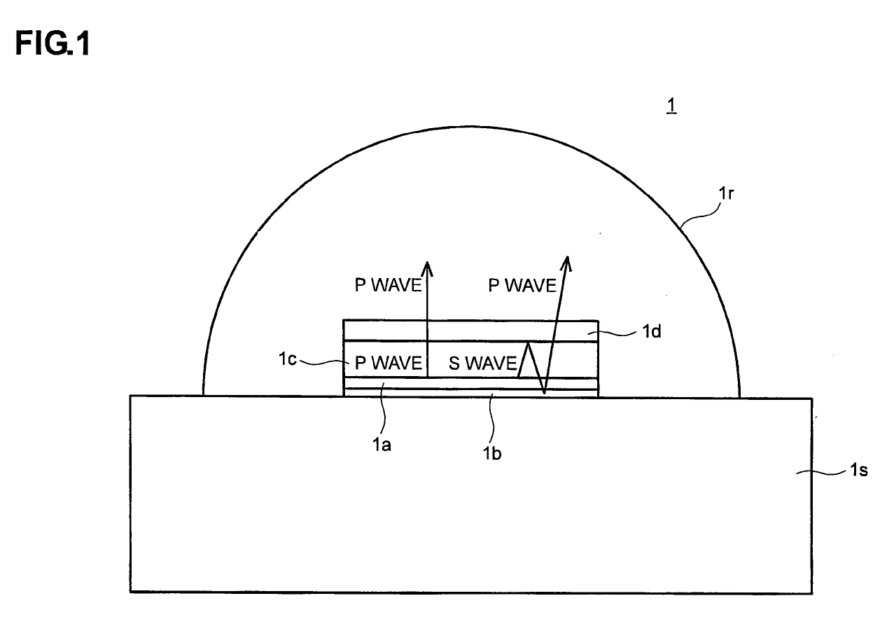

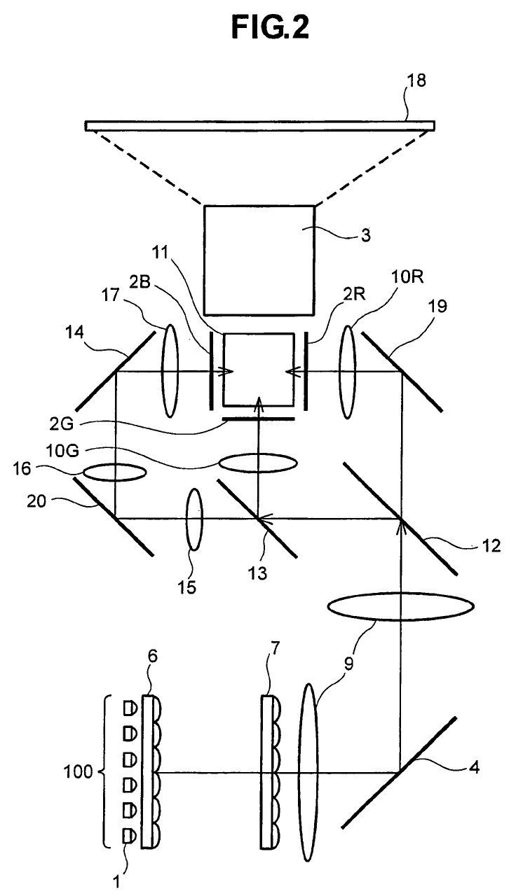

FIG. 1 and FIG. 2 are explanatory diagrams of the first embodiment of the present invention. FIG. 1 illustrates the structure of a semiconductor light-emitting device in accordance with the present invention. FIG. 2 illustrates the configuration of a video display adopting the semiconductor light-emitting device as a light source.

Referring to FIG. 1, there is shown a semiconductor light-emitting device 1. The semiconductor light-emitting device 1 comprises: an LED chip light emitter 1a that emits white light, or any one of red, green, and blue light waves; a reflecting electrode 1b; a sapphire substrate 1c serving as a light transmissive substrate that turns a direction of polarization of light; a reflective sheet polarizer 1d that reflects one of P-polarized light (p wave, P-polarization) and S-polarized light (s wave, S-polarization) and transmits the other polarized light; a resin lens 1r; and a device substrate is. In accordance with one embodiment of the present invention, the semiconductor light-emitting device 1 has a flip-chip structure that the LED chip light emitter 1a is formed on the reflecting electrode 1b.

When a voltage is applied to the LED chip light emitter 1a via the reflecting electrode 1b, the LED chip light emitter 1a emits light (either, white light, or any one of red, green, and blue light waves), and radiates the light towards the sapphire substrate 1c. The light includes P-polarized light and S-polarized light components. One of the polarized light components (e.g., S-polarized light, FIG. 1) is reflected from the reflective sheet polarizer 1d, passes back through the sapphire substrate 1c, through the LED chip light emitter 1a, and is incident on the reflecting electrode 1b.

The incident light is reflected from the reflecting electrode 1b, is through the LED chip light emitter 1a again, passes through the sapphire substrate 1c, and reaches the reflective sheet polarizer 1d. At this time, when the S-polarized light passes through the sapphire substrate 1c after being reflected from the reflective sheet polarizer 1d, and when the S-polarized light passes through the sapphire substrate 1c after being reflected from the reflecting electrode 1b, the polarization of the S-polarized light is rotated so as to be into P-polarized light.

Not all of the S-polarized light radiated from the LED chip light emitter 1a may not be converted into P-polarized light during the first passage through the sapphire substrate 1c after emission from the LED chip light emitter 1a, during the second passage through the sapphire substrate 1c after reflection from the reflective sheet polarizer 1d, and during the third passage through the sapphire substrate 1c after reflection from the reflecting electrode 1b. In this case, the remaining S-polarized light is further converted into P-polarized light during the passage through the sapphire substrate 1c after reflection from the reflective sheet polarizer 1d. The remaining S-polarized light is further converted into P-polarized light during the passage through the sapphire substrate 1c after reflection from the reflecting electrode 1b. Thus, the passage through the sapphire substrate 1c is repeated so that the remaining S-polarized light can be converted into P-polarized light during the passages. The P-polarized light resulting from conversion of the S-polarized light falls on the reflective sheet polarizer 1d. The P-polarized light propagates through the reflective sheet polarizer 1d together with the P-polarized light component of the white light (or any of the red, green, and blue light waves) emitted from the LED chip light emitter 1a. The resultant P-polarized light is radiated to outside the device 1 via the resin lens Ir. Consequently, P-polarized light of white light or any of red, green, and blue light waves whose S-polarized light component is converted into P-polarized light is radiated from the semiconductor light-emitting device 1.

Alternatively, when the material of the reflective sheet polarizer 1d is such that it transmits S-polarized light and reflects P-polarized light, the roles of the P-polarized light and the S-polarized light components described above are switched. The P-polarized light is reflected from the reflective sheet polarizer 1d, passes through the sapphire substrate 1c, is transmitted by the LED chip light emitter 1a, and then falls on the reflecting electrode 1b. The incident light is reflected from the reflecting electrode 1b, is transmitted by the LED chip light emitter 1a again, passes through the sapphire substrate 1c, and reaches the reflective sheet polarizer 1d. At this time, when the P-polarized light passes through the sapphire substrate 1c after being reflected from the reflective sheet polarizer 1d, and when the P-polarized light passes through the sapphire substrate 1c again after being reflected from the reflecting electrode 1b, the P-polarized light has the direction of polarization thereof turned so as to be thus converted into S-polarized light.

Not all if the P-polarized light radiated from the LED chip light emitter 1a may not be converted into S-polarized light during the first passage through the sapphire substrate 1c after emission from the LED chip light emitter 1a, the second passage through the sapphire substrate 1c after reflection from the reflective sheet polarizer 1d, and the third passage through the sapphire substrate 1c after reflection from the reflecting electrode 1b. In this case, the remaining P-polarized light is further converted into S-polarized light during the passage through the sapphire substrate 1c after reflection from the reflective sheet polarizer 1d. The remaining P-polarized light is further converted into S-polarized light during the passage through the sapphire substrate 1c after reflection from the reflecting electrode 1b. Thus, the passage through the sapphire substrate 1c is repeated, and the remaining P-polarized light is duly converted into S-polarized light during the passages. The S-polarized light that is produced by conversion of P-polarized light falls on the reflective sheet polarizer 1d. The S-polarized light is then transmitted by the reflective sheet polarizer 1d together with the S-polarized light component of the white light or any of red, green, and blue light waves emitted from the LED chip light emitter 1a. The resultant S-polarized light is radiated to outside the device 1 via the resin lens 1r. Consequently, S-polarized light of white light or any of red, green, and blue light waves whose P-polarized light component is converted into S-polarized light is radiated from the semiconductor light-emitting device 1.

The foregoing structure adopts the sapphire substrate 1c as a light transmissive substrate that turns the direction of polarization of light. Alternatively, any other suitable substrate may be adopted.

FIG. 2 illustrates the configuration of a projection type video display in accordance with the first embodiment that adopts the semiconductor light-emitting device 1 shown in FIG. 1 as a light source. In the video display, the semiconductor light-emitting device can radiate polarized light of white light whose one polarized light component (e.g., P-polarized light) is converted to become consistent with the other polarized light component (e.g., S-polarized light). The polarized light of white light that is radiated from the semiconductor light-emitting device is separated into polarized light waves of red, green, and blue light waves. The polarized light waves of red, green, and blue light waves are then irradiated to associated video display devices (liquid-crystal panels) in order to form optical images. The optical images are synthesized in terms of colors, and then enlarged and projected from a projection lens unit.

Referring to FIG. 2, there is shown the semiconductor light-emitting device 1 shown in FIG. 1. A projection type video display in accordance with the first embodiment comprises: a light source unit 100 having a plurality of semiconductor light-emitting devices 1 disposed on one plane; a first lens array 6 that comprises a plurality of microscopic lens cells and picks up a plurality of two-dimensional light source images; a second lens array 7 that comprises a plurality of microscopic lens cells and forms the images of the lenses constituting the first lens array 6; condenser lenses 9; reflecting mirrors 4, 14, 19, and 20; dichroic mirrors 12 and 13 serving as a color separation means; relay lenses 15, 16, and 17; a red light condenser lens 10R; a green light condenser lens 10G; a red-light liquid-crystal panel 2R; a green-light liquid-crystal panel 2G; a blue-light liquid-crystal panel 2B; a synthesizer prism 11 serving as a color synthesis means; a projection lens unit 3; and a screen 18. The liquid-crystal panels 2R, 2G, and 2B are driven by drive circuits in accordance with a video signal. The liquid-crystal panels 2R, 2G, and 2B each modulate incident polarized light and radiate resultant light. Moreover, the relay lenses 15, 16, and 17 are included for compensating for a magnitude by which an optical length from the light source unit 100 to the liquid crystal panel 2B is larger than to the liquid crystal panels 2R and 2G. The foregoing optical elements starting with the light source unit 100 to the projection lens unit 3 constitute an optical unit included in the projection type video display.

Owing to the components shown in FIG. 2, light emitted from the plurality of semiconductor light-emitting devices 1 constituting the light source unit 100 (e.g., S-polarized light) passes through the first lens array 7, whereby a plurality of two-dimensional light source images is picked up. Thereafter, the second lens array 7 forms the plurality of two-dimensional light source images. The image-bearing light falls on the condenser lens 9. The S-polarized light of white light concentrated on the condenser lens 9 is reflected from the reflecting mirror 4, whereby the light path is bent substantially at right angles. The S-polarized light falls on the dichroic mirror 12 at an angle of incidence of approximately 45°. The dichroic mirror 12 transmits S-polarized light of red light contained in the white light but reflects S-polarized light waves of green and blue light waves.

The S-polarized light of red light transmitted by the dichroic mirror 12 is reflected from the reflecting mirror 19. Consequently, the S-polarized light changes its path and passes through the condenser lens 10R. The S-polarized light is then converted into P-polarized light by a half-wave phase difference plate or the like. The resultant P-polarized light is irradiated to the red-light transmissive liquid-crystal panel 2R. The P-polarized light of red light is modulated based on a video signal when being transmitted by the liquid-crystal panel 2R. The resultant light is radiated as S-polarized light of red light carrying an optical image from the liquid-crystal panel 2R. The S-polarized light of red light radiated from the liquid-crystal panel 2R falls on the synthesizer prism 11 serving as a color synthesis means. The S-polarized light of red light is reflected from a dichroic surface of the synthesizer prism 11, and routed to the projection lens unit 3.

On the other hand, the S-polarized light waves of green and blue light waves respectively reflected from the dichroic mirror 12 fall on the dichroic mirror 13 at an angle of incidence of approximately 45°. The dichroic mirror 13 reflects the S-polarized light of green light, but transmits the S-polarized light of blue light. The reflected S-polarized light of green light is irradiated to the green-light transmissive liquid-crystal panel 2G via the condenser lens 10G. The S-polarized light of green light is modulated based on a video signal while being transmitted by the liquid-crystal panel 2G. The resultant light is radiated as P-polarized light of green light carrying an optical image from the liquid-crystal panel 2G. The P-polarized light of green light radiated from the liquid-crystal panel 2G is transmitted by the dichroic surface of the synthesizer prism 11, and then routed to the projection lens unit 3.

Moreover, the S-polarized light of blue light transmitted by the dichroic mirror 13 is reflected from the reflecting mirror 20 via the relay lens 15, and further reflected from the reflecting mirror 14 via the relay lens 16. The S-polarized light is converted into P-polarized light by the half-wave phase difference plate or the like via the relay lens 17. The P-polarized light is irradiated to the blue-light transmissive liquid-crystal panel 2B. The P-polarized light of blue light is modulated based on a video signal when being transmitted by the liquid-crystal panel 2B. The resultant light is radiated as S-polarized light of blue light carrying an optical image from the liquid-crystal panel 2B. The S-polarized light of blue light radiated from the liquid-crystal panel 2B falls on the synthesizer prism 11. The S-polarized light of blue light is then reflected from the dichroic surface of the synthesizer prism 11 and routed to the projection lens unit 3.

As mentioned above, the S-polarized light of red light, P-polarized light of green light, and S-polarized light of blue light that have been modulated based on the video signal are radiated from the synthesizer prism 22 while being synthesized in terms of colors. The resultant light falls as white light on the projection lens unit 3. The projection lens unit 3 enlarges the white light and projects it as video light onto the screen 18.

According to the first embodiment of the present invention, a thin light beam of parallel rays can be radiated from the light source unit 100. Consequently, the image quality of displayed video improves. Compared with a configuration employing a lamp or the like, the light source unit can be designed to be compact and lightweight. Because a polarized light converging means need not be disposed on a light path, the number of optical elements is reduced. This results in a compact optical system.

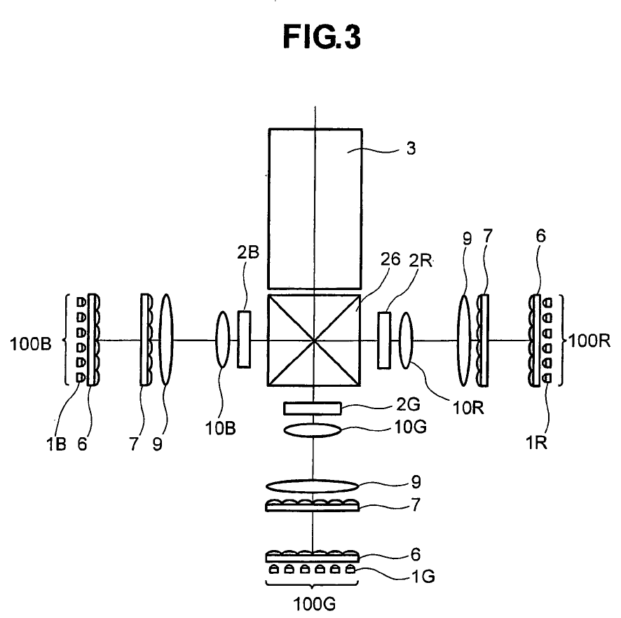

FIG. 3 illustrates the configuration of a projection type video display in accordance with the second embodiment of the present invention. According to the second embodiment, three kinds of semiconductor light-emitting devices, that is, a kind of semiconductor light-emitting device that emits polarized light of red light whose one polarized light component is converted to become consistent with the other component, a kind of semiconductor light-emitting device that emits polarized light of green light whose one polarized light component is converted to become consistent with the other component, and a kind of semiconductor light-emitting device that emits polarized light of blue light whose one polarized light component is converted to become consistent with the other component are adopted as semiconductor light-emitting devices. The fundamental structure of the semiconductor light-emitting devices is identical to that shown in FIG. 1.

Referring to FIG. 3, there are shown a semiconductor light-emitting device 1R that emits polarized light of red light whose one polarized light component is converted to become consistent with the other component, a semiconductor light-emitting device 1G that emits polarized light of green light whose one polarized light component is converted to become consistent with the other component, and a semiconductor light-emitting device 1B that emits polarized light of blue light whose one polarized light component is converted to become consistent with the other component. A projection type video display in accordance with the second embodiment comprises: a red light source unit 100R that has a plurality of semiconductor light-emitting devices 1R disposed on one plane; a green light source unit 100G that has a plurality of semiconductor light-emitting devices 1G disposed on one plane; a blue light source unit 100B that has a plurality of semiconductor light-emitting devices 1B disposed on one plane; a first lens array 6 that comprises a plurality of microscopic lens cells and picks up a plurality of two-dimensional light source images; a second lens array 7 that comprises a plurality of microscopic lens cells and forms the images of the lens constituting the first lens array 6; condenser lenses 9; a red light condenser lens 10R; a green light condenser lens 10G; a blue light condenser lens 100B; a red light transmissive liquid-crystal panel 2R serving as a video display device; a green light transmissive liquid-crystal panel 2G serving as a video display device; a blue light transmissive liquid-crystal panel 2B serving as a video display device; a cross-dichroic prism 26 serving as a color synthesis means; and a projection lens unit 3. The liquid-crystal panels 2R, 2G, and 2B are driven by respective drive circuits according to a video signal. The liquid-crystal panels 2R, 2G, and 2B each modulate incident polarized light and radiates resultant light. The above optical elements starting with the light source units 100R, 100G, and 100B and ending with the projection lens unit 3 constitute an optical unit included in the projection type video display.

Owing to the components shown in FIG. 3, polarized light of red light, of which one polarized component is converted to become consistent with the other component, emitted from the plurality of semiconductor light-emitting devices 1R constituting the red light source unit 100R (P-polarized light or S-polarized light, for example, S-polarized light herein) passes through the first lens array 6, whereby a plurality of two-dimensional light source images is picked up. The second lens array 7 forms the plurality of two-dimensional light source images. The image-bearing light falls on the condenser lens 9. The S-polarized light of red light concentrated on the condenser lens 9 passes through the condenser lens 10R. After the S-polarized light of red light is converted into P-polarized light by a half-wave phase different plate or the like, the P-polarized light is irradiated to the red light transmissive liquid-crystal panel 2R. The P-polarized light of red light is modulated based on a video signal while being transmitted by the liquid-crystal panel 2R, and radiated as S-polarized light of red light carrying an optical image. The S-polarized light of red light radiated from the liquid-crystal panel 2R falls on the cross-dichroic prism 26 serving as a color synthesis means. The S-polarized light of red light is reflected from one dichroic surface of the cross-dichroic prism 26 and then routed to the projection lens unit 3.

Moreover, polarized light of green light, of which one polarized light component is converted to become consistent with the other component, emitted from the plurality of semiconductor light-emitting devices 1G constituting the green light source unit 100G (P-polarized light or S-polarized light, for example, S-polarized light herein) passes through the first lens array 6, whereby a plurality of two-dimensional light source images is picked up. The second lens array 7 forms the plurality of two-dimensional light source images. The image-bearing light falls on the condenser lens 9. The S-polarized light of green light concentrated on the condenser lens 9 is irradiated to the green light transmissive liquid-crystal panel 2G via the condenser lens 10G. The S-polarized light of green light is modulated based on a video signal while being transmitted by the liquid-crystal panel 2G, and then radiated as P-polarized light of green light carrying an optical image. The P-polarized light of green light radiated from the liquid-crystal panel 2G falls on the cross-dichroic prism 26 serving as a color synthesis means. The P-polarized light of green light is transmitted by the cross-dichroic surface of the cross-dichroic prism 26, and routed to the projection lens unit 3.

Likewise, polarized light of blue light, of which one polarized light component is converted to become consistent with the other component, emitted from the plurality of semiconductor light-emitting devices 1B constituting the blue light source unit 100B (P-polarized light or S-polarized light, for example, S-polarized light herein) passes through the first lens array 6, whereby a plurality of two-dimensional images is picked up. The second lens array 7 forms the plurality of two-dimensional light source images. The image-bearing light falls on the condenser lens 9. The S-polarized light of blue light concentrated on the condenser lens 9 passes through the condenser lens 10B. After the S-polarized light is converted into P-polarized light by the half-wave phase difference plate or the like, the P-polarized light is irradiated to the blue-light transmissive liquid-crystal panel 2B. The P-polarized light of blue light is modulated based on a video signal while being transmitted by the liquid-crystal panel 2B, and radiated as S-polarized light of blue light carrying an optical image. The S-polarized light of blue light radiated from the liquid crystal panel 2B falls on the cross-dichroic prism 26 serving as a color synthesis means. The S-polarized light of blue light is reflected by the cross-dichroic surface of the cross-dichroic prism 26, and then routed to the projection lens unit 3.

As mentioned above, the S-polarized light of red light, P-polarized light of green light, and S-polarized light of blue light that are modulated based on the video signal are radiated from the cross-dichroic prism 26 while being synthesized with one another in terms of colors. The resultant white light falls on the projection lens unit 3. The projection lens unit 3 enlarges the white light and projects it as video light onto the screen.

According to the second embodiment of the present invention, a thin light beam of parallel rays can be emitted from each of the red light source unit 100R, green light source unit 100G, and blue light source unit 100B. High-quality video can be displayed. Compared with a configuration employing a lamp or the like, the light source units can be designed to be compact and lightweight. The states of red, green, and blue light waves can be adjusted independently of one another. Consequently, the state of displayed video can be controlled finely. Because a polarized light converging means other than the light source units, and a dichroic mirror or any other color separation means need not be disposed on a light path, the number of optical elements is reduced. Therefore, an optical system can be designed compactly and manufactured readily.

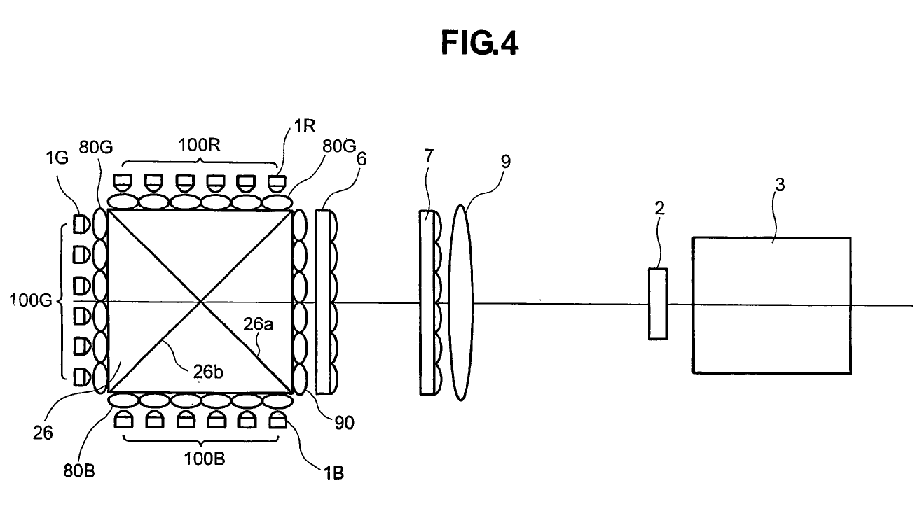

FIG. 4 illustrates the configuration of a projection type video display in accordance with the third embodiment of the present invention. The third embodiment adopts three kinds of semiconductor light-emitting devices as semiconductor light-emitting devices included in light source units. Specifically, a kind of semiconductor light-emitting device that emits polarized light of red light whose one polarized light component is converted to become consistent with the other component, a kind of semiconductor light-emitting device that emits polarized light of green light whose one polarized light component is converted to become consistent with the other component, and a kind of semiconductor light-emitting device that emits polarized light of blue light whose one polarized light component is converted to become consistent with the other component are adopted. Furthermore, polarized light waves of red, green, and blue light waves are radiated in a time-sharing manner, and irradiated to one video display device in order to form an optical image. The fundamental structure of the semiconductor light-emitting devices is identical to that shown in FIG. 1.

Referring to FIG. 4, there are shown a semiconductor light-emitting device 1R that emits polarized light of red light whose one polarized light component is converted to become consistent with the other component, a semiconductor light-emitting device 1G that emits polarized light of green light whose one polarized light component is converted to become consistent with the other component, and a semiconductor light-emitting device 1B that emits polarized light of blue light whose one polarized light component is converted to become consistent with the other component. A projection type video display in accordance with the third embodiment comprises: a red light source unit 100R that has a plurality of semiconductor light-emitting devices 1R disposed on one plane; a green light source unit 100G that has a plurality of semiconductor light-emitting devices 1G disposed on one plane; a blue light source unit 100B that has a plurality of semiconductor light-emitting devices 1B disposed on one plane; red light collimator lenses 80R each of which recomposes light emitted from the semiconductor light-emitting device 1R into light of parallel rays; green light collimator lenses 80G each of which recomposes light emitted from the semiconductor light-emitting device 1G into light of parallel rays; blue light collimator lenses 80B each of which recomposes light emitted from the semiconductor light-emitting device 1B into light of parallel rays; a cross-dichroic prism 26 that aligns the ray axes of red, green, and blue light waves with one another; collimator lenses 90 that recompose light coming from the cross-dichroic prism 26 into light of parallel rays; a first lens array 6 that comprises a plurality of microscopic lens cells and picks up a plurality of two-dimensional light source images; a second lens array 7 that comprises a plurality of microscopic lens cells and forms the images of the lens included in the first lens array 6; a condenser lens 9; a transmissive liquid-crystal panel 2 serving as a video display device; and a projection lens unit 3. The liquid-crystal panel 2 is driven by a drive circuit according to a video signal. The liquid-crystal panel 2 modulates incident polarized light and emits resultant light. The optical elements starting with the light source units 100R, 100G, and 100B and ending with the projection lens unit 3 constitute an optical unit included in the projection type video display.

Among the components shown in FIG. 4, the plurality of semiconductor light-emitting devices 1R constituting the red light source unit 100R, the plurality of semiconductor light-emitting devices 1G constituting the green light source unit 100G, and the plurality of semiconductor light-emitting devices 1B constituting the blue light source unit 100B have their light emitting actions controlled so that they will emit polarized light waves of red, green, and blue light waves respectively in a time-sharing manner. According to the present embodiment, red light, green light, and blue light are emitted and radiated in sequential order. Assuming that red light is emitted, polarized light of red light, of which one polarized light component is converted to become consistent with the other component, emitted from the plurality of semiconductor light-emitting devices 1R constituting the red light source unit 100R (P-polarized light or S-polarized light, for example, S-polarized light herein) is recomposed into light of parallel rays by the red light collimator lens 80R, and routed to the cross-dichroic prism 26. In the cross-dichroic prism 26, the S-polarized light of red light is reflected from one dichroic film 26a and routed to the collimator lens 90. After the S-polarized light of red light is recomposed into light of parallel rays by the collimator lens 90, it falls on the condenser lens 9 via the first lens array 6 and second lens array 7. The S-polarized light of red light concentrated on the condenser lens 9 is irradiated to the transmissive liquid-crystal panel 2. The S-polarized light of red light is modulated based on a video signal while being transmitted by the liquid-crystal panel 2, and then radiated as P-polarized light of red light carrying an optical image. The P-polarized light of red light radiated from the liquid-crystal panel 2 falls on the projection lens unit 3.

Assuming that green light is emitted, polarized light of green light, of which one polarized light component is converted to become consistent with the other component, emitted from the plurality of semiconductor light-emitting devices 1G constituting the green light source unit 100G (P-polarized light or S-polarized light, for example, S-polarized light herein) is recomposed into light of parallel rays by the green light collimator lens 80G, and then routed to the cross-dichroic prism 26. In the cross-dichroic prism 26, the S-polarized light of green light is transmitted by dichroic films 26a and 26b and then routed to the collimator lens 90. The S-polarized light of green light is recomposed into light of parallel rays by the collimator lens 90, and then irradiated to the transmissive liquid-crystal panel 2 via the first lens array 6 and second lens array 7. The S-polarized light of green light is modulated based on a video signal while being transmitted by the liquid-crystal panel 2, and then radiated as P-polarized light of green light carrying an optical image. The P-polarized light of green light radiated from the liquid-crystal panel 2 falls on the projection lens unit 3.

Assuming that blue light is emitted, polarized light of blue light, of which one polarized light component is converted to become consistent with the other component, emitted from the plurality of semiconductor light-emitting devices 1B constituting the blue light source unit 100B (P-polarized light or S-polarized light, for example, S-polarized light herein) is recomposed into light of parallel rays by the blue light collimator lens 30B and then routed to the cross-dichroic prism 26. In the cross-dichroic prism 26, the S-polarized light of blue light is reflected from the dichroic film 26b and routed to the collimator lens 90. The S-polarized light of blur light is recomposed into light of parallel rays by the collimator lens 90 and then irradiated to the transmissive liquid-crystal panel 2 via the first lens array 6, second lens array 7, and condenser lens 9. The S-polarized light of blue light is modulated based on a video signal while being transmitted by the liquid-crystal panel 2, and then radiated as P-polarized light of blue light carrying an optical image. The P-polarized light of blue light radiated from the liquid-crystal panel 2 then falls on the projection lens unit 3.

The projection lens unit 3 enlarges and projects the P-polarized light waves of red, green, and blue light waves. Consequently, video is displayed on the screen or the like.

According to the third embodiment of the present invention, a thin light beam can be emitted from each of the red light source unit 100R, green light source unit 100G, and blue light source unit 100B. Consequently, high-quality video can be displayed. The light source units can be designed to be compact and lightweight. The states of red, green, and blue light waves can be adjusted independently of one another. The state of displayed video can be finely controlled. A polarized light converting means other than the light source units and a color separation means need not be disposed on a light path. Only one liquid-crystal panel 2 is used to construct a video display unit. Consequently, the number of optical elements is reduced. Eventually, an optical system can be designed compactly and manufactured readily.

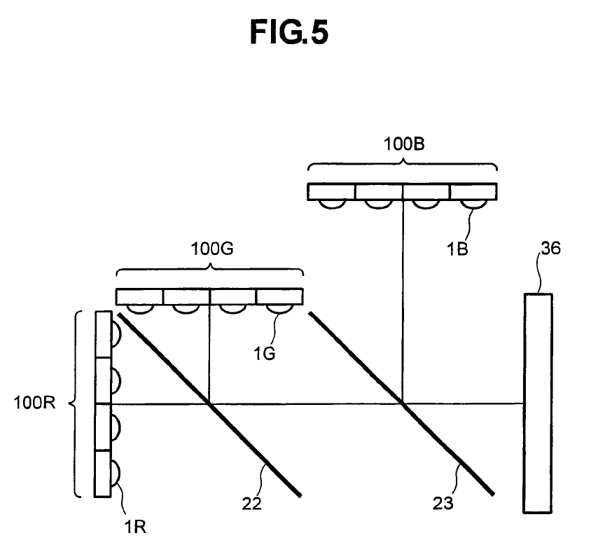

FIG. 5 illustrates the configuration of a video display in accordance with the fourth embodiment of the present invention. Even in the fourth embodiment, a kind of semiconductor light-emitting device that emits polarized light of red light whose one polarized light component is converted to become consistent with the other component, a kind of semiconductor light-emitting device that emits polarized light of green light whose one polarized light component is converted to become consistent with the other component, and a kind of semiconductor light-emitting device that emits polarized light of blue light whose one polarized light component is converted to become consistent with the other component are adopted as semiconductor light-emitting devices to be included in light source units. Furthermore, the polarized light waves of red, green, and blue light waves are emitted in a time-sharing manner, and video is displayed on a direct-vision type video display device. The fundamental structure of the semiconductor light-emitting devices is identical to that shown in FIG. 1.

In FIG. 5, there are shown a semiconductor light-emitting device 1R that emits polarized light of red light whose one polarized light component is converted to become consistent with the other component, a semiconductor light-emitting device 1G that emits polarized light of green light whose one polarized light component is converted to become consistent with the other component, and a semiconductor light-emitting device 1B that emits polarized light of blue light whose one polarized light component is converted to become consistent with the other component. A video display in accordance with the fourth embodiment comprises: a red light source unit 100R that has a plurality of semiconductor light-emitting devices 1R disposed on one plane; a green light source unit 100G that has a plurality of semiconductor light-emitting devices 1G disposed on one plane; a blue light source unit 100B that has a plurality of semiconductor light-emitting devices 1B disposed on one plane; dichroic mirrors 22 and 23; and a direct-vision type display device 36 serving as a video display device. The direct-vision type display device 36 is driven by a drive circuit according to video signals, and modulates incident polarized light so as to form an optical image. The optical elements starting with the light source units 100R, 100G, and 100B and ending with the direct-vision type display device 36 constitute an optical unit included in the video display.

Among the components shown in FIG. 5, the plurality of semiconductor light-emitting devices 1R constituting the red light source unit 100R, the plurality of semiconductor light-emitting devices 1G constituting the green light source unit 100G, and the plurality of semiconductor light-emitting devices 1B constituting the blue light source unit 100B have their light-emitting actions controlled so that they will emit polarized light waves of red, green, and blue light waves in a time-sharing manner. Even in the present embodiment, for example, red light, green light, and blue light are emitted and radiated in that order. Assuming that red light is emitted, polarized light of red light, of which one polarized light component is converted to become consistent with the other component, emitted from the plurality of semiconductor light-emitting devices 1R constituting the red light source unit 100R (P-polarized light or S-polarized light, for example, P-polarized light herein) is transmitted by the dichroic mirrors 22 and 23 and irradiated to the direct-vision type display device 36. The direct-vision type display device 36 modulates the P-polarized light of red light according to a video signal so as to form an optical image.

Assuming that green light is emitted, polarized light of green light, of which one polarized light component is converted to become consistent with the other component, emitted from the plurality of semiconductor light-emitting device 1G constituting the green light source unit 100G (P-polarized light or S-polarized light, for example, P-polarized light herein) is reflected from the dichroic mirror 22 and routed to the dichroic mirror 23. The incident P-polarized light of green light is transmitted by the dichroic mirror 23 and irradiated to the direct-vision type display device 36. The direct-vision type display device 36 modulates the P-polarized light of green light according to a video signal so as to form an optical image.

Assuming that blue light is emitted, polarized light of blue light, of which one polarized light component is converted to become consistent with the other component, emitted from the plurality of semiconductor light-emitting devices 1B constituting the blue light source unit 100B (P-polarized light or S-polarized light, for example, P-polarized light herein) is reflected from the dichroic mirror 23 and irradiated to the direct-vision type display device 36. The direct-vision type display device 36 modulates the P-polarized light of blue light according to a video signal so as to form an optical image.

The P-polarized light waves of red, green, and blue light waves are used to display video on the direct-vision display device 36.

Even in the fourth embodiment of the present invention, each of the red light source unit 100R, green light source unit 100G, and blue light source unit 100B can emit a thin light beam. Consequently, high-quality video can be displayed. Moreover, the light source units can be designed to be compact and lightweight. Moreover, the states of red, green, and blue light waves can be adjusted independently of one another, and the state of displayed video can be controlled readily. A polarized light converting means other than the light source units and a color synthesis means need not be disposed on a light path, and one direct-vision type display device 36 is used to realize a video display unit. Consequently, the number of optical elements can be reduced, and an optical system can be designed compactly.

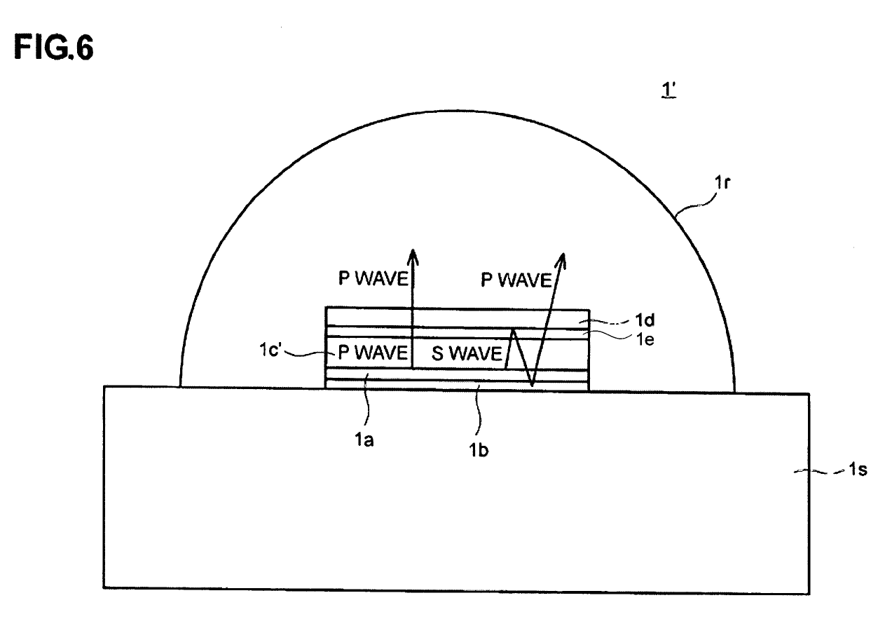

FIG. 6 illustrates the configuration of a semiconductor light-emitting device in accordance with the fifth embodiment of the present invention. In the semiconductor light-emitting device in accordance with the present embodiment, a quarter-wave phase difference plate for turning the direction of polarization is disposed on the light-emitting side of an LED chip light emitter.

Referring to FIG. 6, there is shown a semiconductor light-emitting device 1′. The semiconductor light-emitting device 1′ comprises: an LED chip light emitter 1a that emits white light or any of red, green, and blue light waves; a reflecting electrode 1b; a light transmissive substrate 1c′ realized with a sapphire substrate or the like; a reflective sheet polarizer 1d that reflects one of P-polarized light and S-polarized light and transmits the other polarized light; a quarter-wave phase difference plate 1e that turns the direction of polarization of light; a resin lens 1r; and a device substrate 1s. The semiconductor light-emitting device 1′ has a flip-chip structure that the LED chip light emitter 1a is formed on the reflecting electrode 1b.

Owing to the above components, when a voltage is applied to the LED chip light emitter 1a through the reflecting electrode 1b, the LED chip light emitter 1a emits white light or any of red, green, and blue light waves towards the sapphire substrate 1c. One of the P-polarized and S-polarized light components of the emitted light (herein, S-polarized light component) passes through the substrate 1c′ and quarter-wave phase difference plate 1e, is reflected from the reflective sheet polarizer 1a, passes through the quarter-wave phase difference plate 1e and substrate 1c′, is transmitted by the LED chip light emitter 1a, and falls on the reflecting electrode 1b. The incident light is reflected from the reflecting electrode 1b, is transmitted by the LED chip light emitter 1a again, passes through both the substrate 1c′ and quarter-wave phase difference plate 1e, and reaches the reflective sheet polarizer 1d. At this time, when the S-polarized light passes through at least the quarter-wave phase difference plate 1e after being reflected from the reflective sheet polarizer 1d, and when the S-polarized light passes through the quarter-wave phase difference plate 1e after being reflected from the reflecting electrode 1b, the S-polarized light has the direction of polarization thereof turned and is thus converted into P-polarized light (p wave). Incidentally, during the first passage through the quarter-wave phase difference plate 1e after emission from the LED chip light emitter 1a, during the second passage through the quarter-wave phase difference plate 1e after reflection from the reflective sheet polarizer 1a, and during the third passage through the quarter-wave phase difference plate 1e after reflection from the reflecting electrode 1b, the whole of the S-polarized light (whole of an S-polarized light component of light emitting from the LED chip light emitter 1a) may not be converted into P-polarized light. In this case, the remaining S-polarized light is further reflected from the reflective sheet polarizer 1d, and converted into P-polarized light during the passage through the quarter-wave phase difference plate 1e. The remaining S-polarized light is further reflected from the reflecting electrode 1b and converted into P-polarized light during the passage through the quarter-wave phase difference plate 1e. Thus, while the passage through the quarter-wave phase difference plate 1e is repeated, the remaining S-polarized light is converted into P-polarized light during the passages. P-polarized light into which S-polarized light is converted during the passages through the quarter-wave phase difference plate 1e falls on the reflective sheet polarizer 1d. The P-polarized light is transmitted by the reflective sheet polarizer 1d together with the P-polarized light component of light emitted from the LED chip light emitter 1a, and then radiated to outside the device 1′ via the resin lens 1r. Consequently, P-polarized light of white light or any of red, green, and blue light waves whose S-polarized light component is converted into P-polarized light is radiated from the semiconductor light-emitting device 1′.

On the contrary, when the reflective sheet polarizer 1d transmits S-polarized light and reflects P-polarized light, the P-polarized light is reflected from the reflective sheet polarizer 1d. Thereafter, the P-polarized light passes through the quarter-wave phase difference plate 1e and substrate 1c′, is transmitted by the LED chip light emitter 1a, and then falls on the reflecting electrode 1b. The incident light is reflected from the reflecting electrode 1b, is transmitted by the LED chip light emitter 1a again, passes through the substrate 1c′ and quarter-wave phase difference plate 1e, and then reaches the reflective sheet polarizer 1d. At this time, when the P-polarized light passes through at least the quarter-wave phase difference plate 1e after being reflected from the reflective sheet polarizer 1d, and when the P-polarized light passes through the quarter-wave phase difference plate 1e again after being reflected from the reflecting electrode 1b, the P-polarized light has the direction of polarization thereof turned and is thus converted into S-polarized light (s wave). During the first passage through the quarter-wave phase difference plate 1e after emission from the LED chip light emitter 1a, during the second passage through the quarter-wave phase difference plate 1e after reflection from the reflective sheet polarizer 1d, and during the third passage through the quarter-wave phase difference plate 1e after reflection from the reflecting electrode 1b, the whole of the P-polarized light (whole of a P-polarized light component of light emitted from the LED chip light emitter 1a) may not be converted into S-polarized light. In this case, the remaining P-polarized light is further reflected from the reflective sheet polarizer 1d, and converted into S-polarized light during the passage through the quarter-wave phase difference plate 1e. The remaining P-polarized light is further reflected from the reflecting electrode 1b, and converted into S-polarized light during the passage through the quarter-wave phase difference plate 1e. Thus, while the passage through the quarter-wave phase difference plate 1e is repeated, the remaining P-polarized light is duly converted into S-polarized light during the passages. S-polarized light into which P-polarized light is converted during the passages through the quarter-wave sheet polarizer 1e falls on the reflective sheet polarizer 1d. The S-polarized light is transmitted by the reflective sheet polarizer 1d together with the S-polarized light component of light emitted from the LED chip light emitter 1a, and then radiated to outside the device 1′ via the resin lens 1r. Consequently, S-polarized light of white light or any of red, green, and blue light waves whose P-polarized light component is converted into S-polarized light is radiated from the semiconductor light-emitting device 1′.

Among the foregoing components, assuming that a sapphire substrate is adopted as the substrate 1c′, even when light passes through the sapphire substrate, the direction of polarization of light is turned.

Even when the semiconductor light-emitting device 1′ shown in FIG. 6 is adapted to a light source unit, a video display and an optical unit similar to those shown in FIG. 2, FIG. 3, FIG. 4, or FIG. 5 can be constructed. An operation and advantages to be provided are nearly identical to those described previously.

The first, second, and third embodiments have been described on the assumption that S-polarized light is radiated from a light source unit. Even when P-polarized light is radiated from the light source unit, a configuration, an operation, and advantages are nearly identical to those described previously. The fourth embodiment has been described on the assumption that P-polarized light is radiated from a light source unit. Even when S-polarized light is radiated from the light source unit, a configuration, an operation, and advantages are nearly identical to those described previously. Moreover, a video display is not limited to a liquid-crystal panel.

1. A video display comprising:
an optical unit comprising at least a plurality of first light emitting devices and a light modulator, the first light emitting devices disposed along an optical path of the light modulator, the light modulator operative to modulate light incident thereon to produce modulated light in accordance with a video signal; and
a screen arranged along an optical path of the light modulator to receive the modulated light,
each first light emitting device comprising:
a light emitting layer having a first surface through which light produced therein is transmitted;
a second surface disposed opposite the first surface, the second surface being a reflective surface so that light incident on the second surface is reflected and transmitted through the first surface, the light emitting layer producing light having a first polarization and light having a second polarization, the light being either white light, red light, green light, or blue light;
a light transmissive substrate disposed on the first surface, the light transmissive substrate characterized by rotating the polarization direction of light having the second polarization to the first polarization; and
a reflective substrate disposed on the light transmissive substrate and being transmissive of light having the first polarization and reflective of light having the second polarization, so that light produced by the light emitting layer having the second polarization is reflected toward the second surface through the light transmissive substrate, wherein the light is reflected back toward the reflective substrate by the second surface, whereby light having the first polarization is converted to the second polarization so that the light which is transmitted through the reflective substrate is substantially of the second polarization.

2. The video display of claim 1 wherein the first and second polarizations respectively is either P-polarization and S-polarization, or S-polarization and P-polarization

3. The video display of claim 1 wherein the light transmissive substrate is a sapphire substrate.

4. The video display of claim 1 wherein the light transmissive substrate comprises a quarter-wave plate disposed on a translucent substrate.

5. The video display of claim 1 wherein the first light emitting devices produce white light, the video display further comprising color separators aligned along the optical path of the first light emitting devices, the color separators configured to produce a red light component, a green light component, and a blue light component, and further configured to direct the red, green, and blue light components to the light modulator, wherein the light modulator is operative to modulate each of the red, green, and blue light components individually according to color information in the video signal.

6. The video display of claim 1 wherein the optical unit further comprises a plurality of second light emitting devices and plurality of third light emitting devices, the first light emitting devices producing red light, the second light emitting devices producing green light, the third light emitting devices producing blue light, wherein the light modulator comprises:
a first light modulating element arranged along an optical path of the first light emitting devices to produce modulated red light;
a second light modulating element arranged along an optical path of the second light emitting devices to produce modulated green light;
a third light modulating element arranged along an optical path of the third light emitting devices to produce modulated blue light; and
a light combiner aligned to receive the modulated red light, the modulated green light, and the modulated blue light.

7. The video display of claim 6 further comprising a projection lens disposed between the screen and the light modulator along the optical path of the light modulator, the modulated red, green, and blue light that is received by the light combiner thereby being directed to the projection lens and in turn to the screen.

8. The video display of claim 1 wherein the optical unit further comprises a plurality of second light emitting devices, a plurality of third light emitting devices, and a light combining element, the first light emitting devices producing red light, the second light emitting devices producing green light, the third light emitting devices producing blue light, the light combining element arranged to direct the red light, the green light, and the blue light along the optical path of the light modulator.

9. The video display of claim 8 wherein the first, second, and third light emitting devices are operated in sequential order, so that the red, green, and blue light, respectively, are incident upon the light modulator in sequential order.

10. A video display device comprising:
a light source;
a light modulator to modulate light produced by the light source;
a screen to which modulated light produced by the light modulator is directed,
the light source comprising a plurality of light emitting devices, each light emitting device comprising:
a first layer having an emitting surface and a second layer having a reflecting surface, wherein light produced in the first layer emanates from the emitting surface, wherein light reflected by the reflecting surface emanates from the emitting surface; and
a transmissive substrate having the property of rotating the polarization direction of light having a first polarization, the transmissive substrate arranged with respect to the light emitting device so that light having a second polarization that is incident upon the transmissive substrate propagates therethrough.

11. The video display of claim 10 wherein the first polarization is P-polarization and the second polarization is S-polarization, wherein light that emanates from the transmissive substrate is substantially S-polarized light.

12. The video display of claim 10 wherein the first polarization is S-polarization and the second polarization is P-polarization, wherein light that emanates from the transmissive substrate is substantially P-polarized light.

13. The video display of claim 10 further comprising a reflective substrate having the property of reflecting light having the first polarization and being transmissive of light having a second polarization, the reflective substrate arranged in a manner to receive light that propagates through the transmissive substrate and to reflect light having the first polarization toward the reflective surface of the LED, wherein light produced by the LED having the first polarization reflects between the reflective substrate and the reflective surface of the LED at least once, and emanates from the reflective substrate as light having the second polarization.

14. The video display of claim 13 wherein the transmissive substrate is a sapphire substrate.

15. The video display of claim 13 wherein the transmissive substrate is a quarter-wave plate.

16. The video display of claim 15 wherein each LED further comprises a sapphire substrate, the quarter-wave plate being disposed on the sapphire substrate.

17. The video display of claim 13 wherein the light source produces white light, wherein the light modulator includes one or more beam splitters to produce a red light component, a green light component, and a blue light component from the white light, and light modulating components to modulate each of the red, green, and blue light components.

18. A light emitting device comprising:
a light emitting component and a reflective electrode to which the light emitting component is in electrical contact, wherein light incident on the reflective electrode is reflected, the light emitting component operative to produce light having a first polarization and light having a second polarization;
a light transmissive substrate disposed relative to the reflective electrode such that the light emitting component is disposed therebetween, the light transmissive substrate characterized by rotating the polarization direction of light having the first polarization to the first polarization; and
a reflective substrate being transmissive of light having the first polarization and reflective of light having the second polarization, the reflective substrate disposed relative to the light transmissive substrate so as to reflect a first light having the second polarization toward the reflective electrode through the light transmissive substrate and through the light emitting component,
wherein the first light is reflected back toward the reflective substrate by the reflective electrode.

19. The semiconductor light emitting device according to claim 18 wherein the first and second polarizations each is either P-polarization and S-polarization respectively, or S-polarization and P-polarization respectively.

20. The semiconductor light emitting device according to claim 18 wherein the light transmissive substrate is a sapphire substrate.

21. The semiconductor light emitting device according to claim 18 wherein the light transmissive substrate comprises a quarter-wave plate.

22. The semiconductor light emitting device according to claim 21 wherein the light transmissive substrate further comprises a sapphire substrate, the quarter-wave plate being disposed on the sapphire substrate.

23. The semiconductor light emitting device according to claim 18 wherein the light produced by the light emitting component is one of white light, red light, green light, or blue light.
